(19) United States
(12) Patent Application Publication
(10) Pub. No.: US 2003/0149789 A1
(43) Pub. Date: Aug. 7, 2003

(54) Efficient changing of address information using NAT and NAPT routers with separate transmission of payload data and signaling information

(76) Inventor: Klaus Hoffmann, Munchen (DE)

Correspondence Address: Kevin R. Spivak, Morrison & Foerster LLP, Suite 300, 1650 Tysons Boulevard, McLean, VA, 22102, US

(21) Appl. No.: 10/281,273

(22) Filed: Oct. 28, 2002

(30) Foreign Application Priority Data
Oct. 29, 2001 (EP) 01125791.2

(51) Int. Cl. G06F 15/16; G06F 15/173

(52) U.S. Cl. 709/245; 709/246; 709/238

(57) ABSTRACT

The invention relates to a method for changing address information for networks with separate transmission of payload data and signaling information, in which the network administration is handled by means of the IN (intelligent network) concept and the payload data are transmitted via a packet network (IPNET). In the method according to the invention, the address information to be changed in the signaling information is extracted in an SSP (service switching point) and transmitted with an appropriately adapted INAP (intelligent network application part) to an SCP (service control point). The address is changed in the SCP using means provided there. The changed address information is then transmitted back to the SSP. The invention efficiently uses the IN concept for changing address information of signaling information. Disadvantages of conventional methods are avoided.

### CLAIM FOR PRIORITY

This application claims priority to Application No. 01125791.2 which was filed in the German language on Oct. 29, 2001.

### TECHNICAL FIELD OF THE INVENTION

The invention relates to a method for changing address information for networks with separate transmission of payload data and signaling information.

### BACKGROUND OF THE INVENTION

Separating the transmission of payload data and signaling information leads to additional switching requirements, for example in the changing of address information.

There are constellations in which it is appropriate to change address information during the data transmission via a packet network. The NAT (network address translation) technique is aimed at greater flexibility in the issuing of host addresses and enables the address base in packet networks to be enlarged. Converting local address information by using a NAT router reduces the necessity for issuing globally valid and consistent addresses. For this reason, NAT routers are frequently used for connecting private networks to one another or to a global public network. Before the NAT router transmits packets to another network, it converts locally valid address information into address information which is valid in the other network. A corresponding conversion of address information is performed for packets arriving from the other network.

In addition, the NAT technique is used in connecting different address ranges of a network.

To obtain more flexibility in applications in IP (Internet protocol) networks, the port address is also frequently converted in addition to the IP address. This is called network address port translation (NAPT).

For IP networks, aspects of the changing of address information by means of NAT and NAPT routers are described in the Internet Standard RFC (Request for Comments) 2663.

When using NAT and NAPT devices in conjunction with SS7 (signaling system No. 7) networks in which payload data and signaling information are carried separately, a change in address information in packets with payload data must entail a matching change in signaling information.

It is known to provide an additional TDM (time division multiplex) loop for changing addresses during the transmission of data in SS7 networks. This solution requires additional hardware.

### SUMMARY OF THE INVENTION

The invention specifies an improved method for changing address information in SS7 networks.

In one embodiment according to the invention, the network management is structured in accordance with the IN (intelligent network) concept described in ITU (International Telecommunications Union) series Q.1200. To change address information, a device for changing addresses are provided in an SCP (service control point). The address information to be changed is extracted from the signaling information in an SSP (service switching point) and the extracted address information is transmitted to the SCP by means of an adapted INAP (intelligent network application protocol). The address information is changed in the SCP using the device provided. The changed address information is transmitted from the SCP to the SSP by means of an adapted INAP (intelligent network application part) protocol and the changed address information is inserted into the signaling information.

The procedure efficiently uses the IN (intelligent network) concept for changing address information of signaling information.

In one embodiment of the IN architecture, three hierarchy levels are provided: the management level, the service control level and the switching and transport level. The switching centers, here designated by SSP (service switching point) in accordance with the literature, are controlled by control centers, called SCP (service control point), of the service control level. The elements SSP and SCP, which matter for the invention, are defined in ITU (International Telecommunications Union) Standard Q.1205. The address information to be changed and the changed address information is transmitted by the INAP protocol used in IN applications. General aspects of the INAP protocol are listed in the ITU Standard Q.1205.

Another embodiment according to the invention allows address changes to be performed without additional TDM loop during the transmission of payload data in the packet network. The device for changing the address information, e.g. address translation tables, are provided in the SCP and are thus available to all facilities controlled via the SCP. A change in the payload data transmitted via a packet network, which corresponds to the change in address information in the signaling information, can be performed in an NAT router or an NAT/NAPT router. Apart from changing host addresses, e.g. IP (Internet protocol) addresses, an NAT/NAPT router allows port addresses to be changed.

The signaling protocol used can be, for example, the BICC (bearer independent call control) protocol, the SIP-T (session initiation protocol for telephony) or an ISUP (ISDN user part) protocol adapted for packet network transmission of payload data. When using the BICC protocol, the BICC information element BEARER CONTROL INFORMATION can be used for changing address information. This information element includes address information. This address information can be extracted from the information element and changed in the SCP after having been transmitted from the SSP to the SCP by means of correspondingly adapted or extended INAP procedures. INAP procedures which can be used appropriately adapted to the change in address information by means of the information element BEARER CONTROL INFORMATION (these information elements are specified in ITU-T Standards Q.765.5, Q.1970 and Q.1990) are INITIAL DP, CONNECT, EventReportBCSM and ContinueWithArgument.

Using the information element BEARER CONTROL INFORMATION saves additional changes. As an alternative, an additional INAP parameter can be introduced which, in contrast to the information element BEARER CONTROL INFORMATION, comprises the address information to be changed, for example IP addresses. The expenditure for introducing a new parameter has the advantage of reducing the data volume transmitted between SSP and SCP. In addition, this implementation is not BICC-specific.

When address information is changed on transition between two domains of the packet network, it may be desirable to provide resources for changing address information in both domains. For this purpose

the signaling information is conducted via two SSPs, one of which is in each case associated with one domain and in each case changes the addresses of signaling information leaving the associated domain,

an SCP which changes the address information is associated with each SSP, and

the payload data are conducted via two NAT routers or NAT/NAPT routers, one of which is in each case associated with one domain and in each case changes the addresses of payload data leaving the associated domain.

Thus, information about the network topology of one domain in each case can be made inaccessible by the other one due to the address change, for example in the case of two privately administered domains. Such safety requirements can also occur in public networks, for example in military facilities. The term “domain” designates a delimited address space, for example corresponding to the DNS (domain name system) used in the Internet. It is an economic solution to implement the functions of the two SCPs and of the two NAT routers or NAT/NATP routers in each case in a physical unit. However, this may result in authorization questions, e.g. with regard to the access to the jointly used hardware. It may be desirable to have an administration of the hardware used jointly by the domains which is independent of the domain management.

The functions of the SSP can be implemented in a controller normally abbreviated by MGC (media gateway controller) or in a CMN (call mediation node). Within the context of the BICC concept, call mediation nodes are optional physical elements (see e.g. Q.1901).

If address information is changed during the setting-up of a connection, an APP (application transport parameter) of an IAM (initial address message) can be evaluated for address information in order to change address information, and the address information of the APP parameter can be changed. Solutions for signaling address information other than with the aid of the APP parameter, for example priority-based or proprietary methods, are also conceivable.

### BRIEF DESCRIPTION OF THE DRAWINGS

In the text which follows, the invention will be represented in the context of exemplary embodiments, with the aid of figures in which:

FIG. 1 shows a system for connecting two network areas.

FIG. 2 shows a system for connecting two network areas with transmission of signaling information via two CMNs.

### DETAILED DESCRIPTION OF THE INVENTION

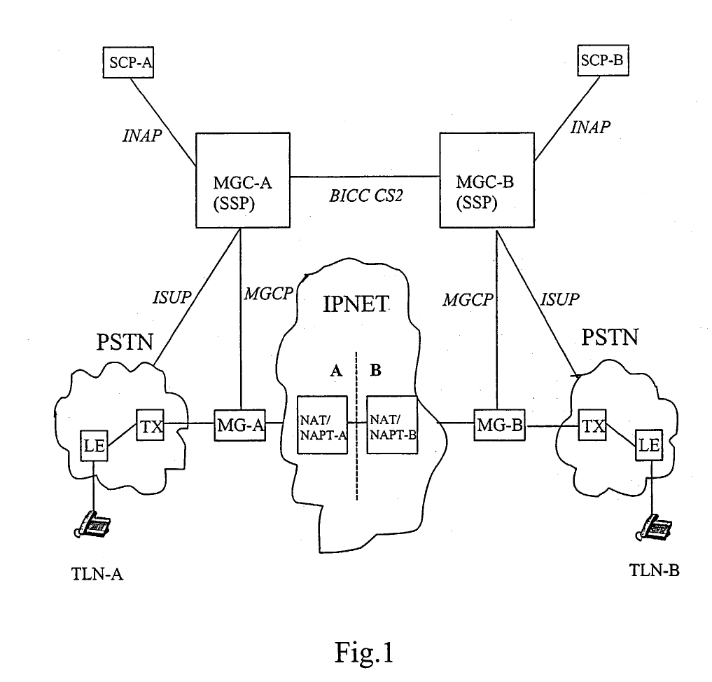

FIG. 1 shows a system for connecting two network areas. In the exemplary embodiment, an interconnection of two PSTN (public switched telephone network) terminals TLN-A and TLN-B is conducted via a packet-oriented network IPNET, for example a network based on the Internet protocol, or a network based on ATM technology. Both of the terminals TLN-A and TLN-B involved are connected to a PSTN network. For PSTN networks, time division multiplexing (TDM) is normally used in order to combine data from various terminals or channels and to transmit these data via high-capacity trunk lines, frequently called trunks. As provided in the SS#7 signaling system, payload data and control information are conducted separately in the connection. The payload data are transmitted from the terminal TLN-A to a local exchange LE close to the subscriber and are transmitted from there to a transit exchange TX. The transit exchange TX is connected to a media gateway MG-A which is provided for processing TDM payload data for transmission via a packet network IPNET. Payload data transmitted via the packet network IPNET during a speech application are processed by another media gateway MG-B at the receiver end and are then transmitted via a PSTN network, first to a transit exchange TX and then finally to a local exchange LE close to the subscriber, and to the subscriber terminal TLN-B.

For the exemplary embodiment, it is assumed that in the connection between the terminals TLN-A and TLN-B, address changes are performed during the transport of payload data between two areas or domains A and B of the packet network IPNET. The separation between the two areas is indicated by means of a dashed line in the figure. The addresses are changed by NAT/NAPT router NAT/NAPT-A with the aid of address translation tables for the payload data. In the context of the exemplary embodiment, address changes are provided for the exchange of data in both directions of transmission of the connection which is why two interconnected NAT/NAPT routers NAT/NAPT-A and NAT/NAPT-B are provided on different sides of the domain boundary. Such a constellation is typically given at the transition between two private packet network areas. When a private network area is connected together with a public one, only NAT/NAPT routers will be positioned on the side of the private network area as a rule. In the exemplary embodiment, changes of IP addresses and port addresses during the setting-up of a connection via the packet network IPNET are described. However, a changing of addresses according to the invention relate to the IP address. In the context of the exemplary embodiment, it is assumed that address information is changed for both domains. During the transmission of information over the domain boundary from area A to area B, address information relating to the address of the transmitter on the A side, on the one hand, and, on the other hand, address information relating to the address of the receiver on the B side are changed. As a result, there is more freedom in issuing addresses in both areas A and B. It is not so easy to find out details about the respective network topology within the area from the addressing.

The signaling information for setting up the connection is transmitted to media gateway controller MGC-A which is associated with the media gateway MG-A on the A side. To control the setting-up of the connection, the controller MGC-A communicates with the media gateway MG-A on the A side and the controller MGC-B on the B side. In the context of the IN concept, the controllers MGC-A and MGC-B correspond to physical elements of the switching level usually called SSP (service switching point). In the figure, this is shown by the abbreviation SSP in brackets.

According to the IN concept, control functions are handled by an SCP, SCP-A for area A and SCP-B for area B. The reference symbols of the protocols used for exchanging signaling information are written in italics in the figure. Signaling information transmitted to the controllers MGC-A and MGC-B via the PSTN networks are transmitted by means of the ISUP (ISDN user part) protocol. To exchange information between the controllers MGC-A and MGC-B and the media gateways MG-A and MG-B, a media gateway control protocol MGCP, possibly adapted to proprietary requirements, is used. As an alternative, communication between the controllers MGC-A and MGC-B and the media gateways MG-A and MG-B can also take place by means of the H.248 protocol standardized by the ITU (International Telecommunications Union). Signaling between the two controllers MGC-A and MGC-B is done by means of the BICC CS2 protocol. As an alternative, an ISUP protocol adapted to proprietary requirements ISUP+ or the SIP-T (session initiation protocol) can be used. To exchange signaling information between SSP and SCP, the INAP protocol extended for changing address information is used.

The ITU publications Q.762 and Q.763 and the designs for Q.763 (addendum) and Q.765 show that, in the ISUP and the BICC based on the ISUP, the connection set-up is initiated by means of a connection set-up message IAM (initial address message) which comprises a parameter filed APP (application transport parameter). Address information to be changed is extracted from the parameter field APP of an incoming initial address message IAM arriving in the controller MGC-A. This information is then transmitted to the SCP of the controller.

In the text which follows, the sequence of the method according to the invention is explained with the example of a connection set-up. For the sake of simplicity, it is assumed that only IP addresses are changed. Other address information, for example port addresses, would be changed analogously. During the connection set-up, the two media gateways MG-A and MG-B are supplied with destination addresses for transmitting payload data packets. The connection is set up by means of an IAM (initial address message) which is transmitted from the controller MGC-A to the controller MGC-B and which comprises a parameter field APP which includes the IP address of the media gateway.

The method can also be used in other constellations, for example for changing an existing connection. The IP address of the media gateway MG-A is changed in the SCP SCP-A in accordance with the address translation tables provided there, and the changed IP address is transmitted again from the SCP SCP-A to the SSP or, respectively, to the controller MGC-A. The changed IP address is then entered in the parameter field APP of the IAM. The IAM, the transmission of which is still retarded while the address information is being changed, is then transmitted to the controller MGC-B during the setting-up of the connection. The controller MGC-B extracts the changed IP address of the media gateway MG-A and transmits it to the media gateway MG-B. This changed IP address of the media gateway MG-A is used by the media gateway MG-B as destination address for transmitting payload data packets to the media gateway MG-A. During the further setting-up of the connection, the media gateway MG-A is also supplied with a destination address. For this purpose, a message with the destination address is transmitted from the controller MGC-B to the controller MGC-A. During this process, the IP address of the media gateway MG-B is changed in the SCP SCP-B in accordance with the address translation table provided there. The media gateway MG-A receives the changed IP address of the media gateway MG-B as destination address for the connection to the terminal.

During the transmission of payload data packets between the media gateways MG-A and MG-B, the respective media gateway uses its own IP address as source address and the changed IP address of the other media gateway as destination address. A payload data packet which is transmitted by the media gateway MG-A initially passes via the NAT router NAT/NAPT-A where the source address of the packet is changed. The changed address corresponds to the media gateway MG-B for transmitting packets to the destination address reported to media gateway MG-A. The packet with the changed source address is then transmitted to the NAT router NAT/NAPT-B where the destination address of the packet which corresponds to the changed IP address of the media gateway MG-B is replaced by the real IP address of MG-B and is forwarded to the media gateway MG-B.

The address information is transmitted between the SSP and SCP with the aid of the INAP protocol adapted or extended for this purpose. This can be done either with the aid of the information element BEARER CONTROL INFORMATION or by defining a new INAP parameter. In a format based on the SDP (session description protocol), the information element BEARER CONTROL INFORMATION contains IP address and port address information relating to payload data transmission. This information element is transmitted from the SSP to the SCP with the INAP procedure INITIAL DP extended for this purpose. In the SCP, means are provided for processing the information element and for extracting the address information. After it has been changed with the aid of the address translation tables, the changed address information is then transmitted to the controller MGC-A and MGC-B, respectively, by means of the INAP procedure CONNECT adapted for this purpose.

In the context of the IN concept, detection points can be set or defined at the switching level for exchanging control information between control and switching level (see Q.1224). In the IN terminology, these detection points are abbreviated by DP. In a DP, signaling information requiring an SCP-SSP interaction can be detected and an information exchange between SCP and SSP for connection or service control can be triggered. When a DP is set, the information element BEARER CONTROL INFORMATION can be transmitted from the SSP to the SCP by means of the INAP Procedure EventReportBCSM adapted for this purpose and the new address information can be transmitted from the SCP to the SSP by means of the appropriately adapted INAP procedure ContinueWithArgument. The procedures EventReportBCSM and ContinueWithArgument can be used, for example, during the changing of an existing connection or in the conversion of the IP addresses for the reverse direction (from B to A) during connection set-up.

As an alternative to using the information element BEARER CONTROL INFORMATION, a new INAP information element can be defined which includes the relevant address information, e.g. IP addresses and port addresses but not other information comprised in the information element BEARER CONTROL INFORMATION.

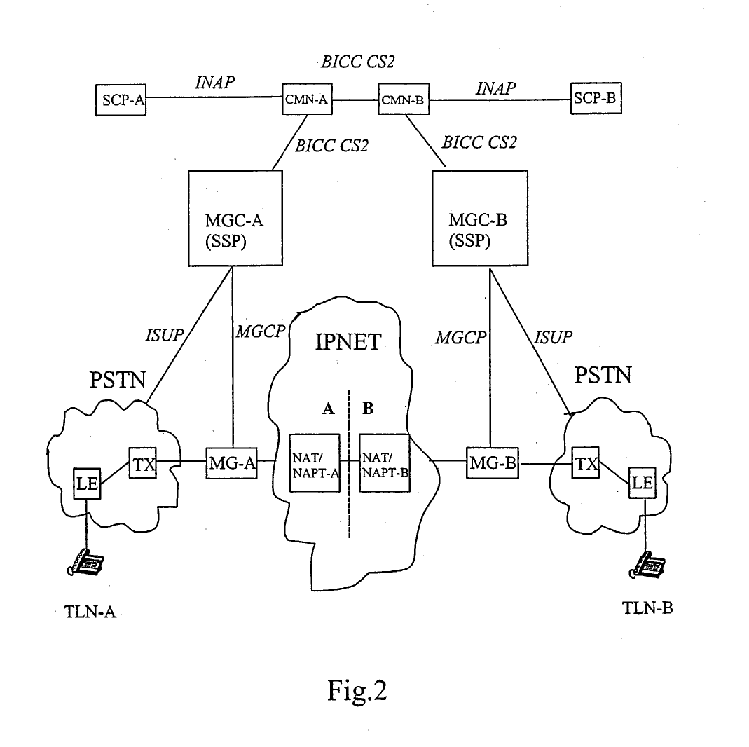

The BICC protocol optionally allows physical elements to be used which are called CMNs (call mediation nodes) (but without direct access to payload data routers/media gateways), which could also be provided with SSP functions (see e.g. ITU-T Standard Q.1901 and, for a summary of the IN-related terms, Q.1290). As an alternative, the address information contained, for example, in the APP of the IAM or the return message with the destination address for the media gateway MG-A during a connection set-up, can also be changed in CMNs (call mediation nodes) CMN-A and CMN-B which are interposed between controllers MGC-A and MGC-B and which are controlled by the SCPs SCP-A and SCP-B, respectively (FIG. 2). During a connection set-up according to FIG. 2, the IAM would then be transmitted from the controller MGC-A to the CMN-A where it is changed and then transmitted on to the MGC-B via the CMN-B. This correspondingly applies to the return message.

The invention can also be used in constellations other than that shown in the figure. For example, SCP and SSP can be implemented in an arrangement where the corresponding functions are implemented by the circuit logic and the software of the arrangement. In this connection, experts frequently use the term integrated service logic. For example, the functions of the service switching center CMN can also be implemented spatially combined with one of the controllers MGC-A or MGC-B.

At the subscriber end, a so-called residential gateway, i.e. a gateway within the area of responsibility of the subscriber, can be used instead of the access via a PSTN network, or a terminal at the subscriber end can support voice-based packet network services (for example with the aid of the H.323 protocol or of the SIP protocol).

1. A method for changing address information for networks with separate transmission of payload data and signaling information, in which
the network administration is handled by means of the IN (intelligent network) concept,
the payload data are transmitted via a packet network (IPNET),
means for changing addresses are provided in an SCP (service control point),
address information to be changed is extracted from the signaling information in an SSP (service switching point),
the extracted address information is transmitted to the SCP by means of an adapted INAP (intelligent network application part) protocol,
the address information is changed in the SCP using the means provided,
the changed address information is transmitted from the SCP to the SSP by means of an adapted INAP protocol, and
the changed address information is inserted into the signaling information.

2. The method as claimed in claim 1, characterized in that
the address information of the payload data is changed in an NAT (network address translation) router or an NAT/NAPT (network address translation/network address port translation) router, which change corresponds to the change in address information in the signaling information.

3. The method as claimed in claim 1 or 2, characterized in that
the means for changing the address information comprise address translation tables.

4. The method as claimed in one of the preceding claims, characterized in that
the address information comprises IP (Internet protocol) addresses and/or port addresses.

5. The method as claimed in one of the preceding claims, characterized in that
the BICC (bearer independent call control) protocol, the SIP-T (session initiation protocol) or an ISUP (ISDN user part) protocol adapted for packet network transmission of payload data is used as signaling protocol.

6. The method as claimed in one of the preceding claims, characterized in that
the BICC (bearer independent call control) protocol is used as signaling protocol,
in the SCP, resources for influencing the BICC-specific information element BEARER CONTROL INFORMATION are provided,
the information element BEARER CONTROL INFORMATION is transmitted to the SCP with an INAP procedure adapted for this purpose, and
address information comprised in the information element BEARER CONTROL INFORMATION is extracted from the information element and changed in the SCP.

7. The method as claimed in one of the preceding claims, characterized in that
a new INAP parameter is defined which comprises the address information to be changed, and
the address information to be changed is transmitted from the SSP to the SCP with the aid of this INAP parameter.

8. The method as claimed in one of the preceding claims, characterized in that
at least one of the INAP procedures INITIAL DP, CONNECT, EventReportBCSM and ContinueWithArgument is used for the changing of address information, the INAP procedures used being adapted for the transmission of address information or, respectively, of the information element BEARER CONTROL INFORMATION.

9. The method as claimed in one of the preceding claims, characterized in that
during the method, address information is changed at the transition between two domains (A,B) of the packet network, wherein
the signaling information is conducted via two SSPs, one of which is in each case associated with one domain and in each case changes the addresses of signaling information leaving the associated domain,
an SCP which changes the address information is associated with each SSP, and
the payload data are conducted via two NAT routers or NAT/NAPT routers, one of which is in each case associated with one domain and in each case changes the addresses of payload data leaving the associated domain or arriving in the associated domain.

10. The method as claimed in claim 9, characterized in that
the functions of the two SCPs and of the two NAT routers or NAT/NATP routers are in each case implemented in a physical unit.

11. The method as claimed in claim 9 or 10, characterized in that
the functions of the two SSPs are implemented in a physical unit.

12. The method as claimed in one of the preceding claims, characterized in that
the functions of the SSP are implemented in a media gateway controller (MGC).

13. The method as claimed in one of the preceding claims, characterized in that
the functions of the SSP are implemented in a CMN (call mediation node).

14. The method as claimed in one of the preceding claims, characterized in that
address information is changed during the setting-up of a connection,
in order to change address information, an APP (application transport parameter) of an IAM (initial address message) is evaluated for address information, and
address information of the APP parameter is changed.
